(19) United States
(12) Patent Application Publication
(10) Pub. No.: US 2020/0215731 A1
(43) Pub. Date: Jul. 9, 2020

(54) A PROCESS FOR PRODUCING A MOLDED ARTICLE AND THE MOLDED ARTICLE PRODUCED THEREBY

(71) Applicant: Covestro Deutschland AG, Leverkusen (DE)

(72) Inventors: Yilan LI, Shanghai (CN); Eric QI, Shanghai (CN); Jack CHANG, Taipei City (TW); Sean GAO, Shanghai (CN); Olaf ZÖLLNER, Leverkusen (DE); Thomas GRIMM, Köln (DE)

(21) Appl. No.: 16/473,510

(22) PCT Filed: Dec. 19, 2017
(86) PCT No.: PCT/EP2017/083511

§ 371 Date: Jun. 25, 2019

(30) Foreign Application Priority Data
Dec. 23, 2016 (CN) PCT/CN2016/111739

(51) Int. Cl. B29C 45/14; B32B 27/08

(52) U.S. Cl. CPC B29C 45/14786; B32B 27/365; B32B 27/08

(57) ABSTRACT

Process for producing a molded article, comprising a long fiber thermoplastic composite sheet (1) and a short fiber filled thermoplastic (2,3) component, preferably injected over the surface of the composite sheet, that are thermoformed.

### TECHNICAL FIELD

The present invention relates to a process for producing a molded article, particularly, to a process for producing a molded article from a continuous fiber-reinforced thermoplastic polymer composite sheet, especially a process for producing the housing or part of the housing of a laptop or a cell phone. Furthermore, the present invention relates to a molded article produced by the process according to the present invention, in particular to the housing or part of the housing of an electronic product produced from a continuous fiber-reinforced thermoplastic polymer composite sheet.

### BACKGROUND ART

For housing material of consumer electronics parts, for instance, among the housing parts of a laptop, the A-Cover, which is the outermost housing layer comprising liquid crystal display (LCD), is intended for, among others, surrounding and protecting the LCD. When it is made of continuous carbon fiber reinforced thermoplastic composite materials, normally the production includes two steps; in step i) thermoforming the continuous carbon fiber reinforced thermoplastic polymer composite sheet to form a main structure, in this step, usually the decoration parts such as logo or brand name will be formed; and in step ii) injection molding the glass fiber filled materials such as resin, so as to introduce the structures and functional parts (such as screw column and reinforcing rib) onto the thermoforming molded composite sheet. In the injection molding of step ii), the technical problem of signal shielding could be addressed by replacing carbon fiber filled thermoplastic polymer composite with glass fiber filled resin in specific areas.

Nevertheless, owing to design limitations (e.g., spatial limitation and thin wall housing) at the bonding area between the glass fiber filled resin and the composite sheet and to the properties of the injection molding itself, the bonding strength between the glass fiber filled resin and the composite sheet is not strong enough to pass the original equipment manufacturer (OEM) specification.

In addition, in the two-step process (firstly thermoforming and then injection molding) commonly used in the prior art, a bonding line does inevitably form between the glass fiber filled resin and the composite sheet. Such bonding line may need to be modified by an additional polishing step, because the composite sheet area and the glass fiber filled resin part may not be at the same level or slightly differ in height. As to the coated article, surface defects have been observed in the bonding area in many instances, and the bonding line is still visible after polishing.

In addition, in the current two-step process, yield rate needs to be calculated in every step. Thus, every step would substantially affect the final yield rate.

Since the glass fiber filled resin and the composite sheet are different in terms of shrinkage rate, a warpage problem exists in the prior art process. Besides, in the prior art process, owing to the 2-shot molding and the bonding strength, glass fiber filled resin requires filling a relatively large area, such as the whole frame around the composite sheet, sometimes in order to increase bonding, it may require an overlapping region with the composite sheet. This leads to a higher risk of warpage and a smaller remaining space.

Another process known in the art is described in US 2014/18609 A1. This documents describes that a fiber composite with a thermoset as matrix material is formed on which at least one plastic part is formed. A coupling agent layer and an adhesive layer bind the plastic part to the composite part. This process requires several steps.

### SUMMARY OF THE INVENTION

The present invention addresses one or more of the above-mentioned problems.

The present invention provides a process for producing a molded article which comprises a composite part and at least one functional and/or structural thermoplastic part, wherein the composite part and the functional and/or structural thermoplastic part are directly attached to each other, wherein the process comprises the following steps:
i) providing a composite sheet containing a thermoplastic material a and continuous fibers and comprising at least one preset region used for forming said at least one functional and/or structural thermoplastic part,
ii) applying a preset volume of thermoplastic material b comprising short fibers at said at least one preset region; and
iii) thermoforming said composite sheet and said thermoplastic material b into the molded article in one step, wherein the composite sheet is thermoformed to form said composite part and the thermoplastic material b is thermoformed to form the at least one functional and/or structural thermoplastic part.

Where there is mentioned a specific thermoplastic material in the description of the invention, this does not only mean the polymer as such, e.g. aromatic polycarbonate, but also a composition comprising the respective polymer comprising conventional additives such as fillers, mold release agents, antioxidants, thermal stabilizers and/or colorants.

The functional/and or structural part is a part which fulfills a function such a being a connection element, reinforcing part of the housing, being non-shielding against signal beams.

The functional part is preferably selected from the group consisting of screw column, snap fits, screw bosses and signal sending and receiving areas, and the structural part preferably is a reinforcing rib.

More preferably, the functional part is a signal sending and receiving area which is in the form of two rectangles, with the preset region being such that the distance between the symcenter of the two rectangles and the lower edges of the composite sheet is 0.1-1 cm, and the distances between the left and right rectangles and the left and right edges of the composite sheet are 0.2-5 cm respectively.

Alternatively or in addition thereto, the functional part preferably is a screw column which is a cylinder having an inner diameter of 2.5-4 mm, with the preset region being such that the distances between the axes of the cylinder and the left and right edges of the composite sheet are 0.1-1.5 cm respectively.

Alternatively or in addition thereto, the structural part preferably is a reinforcing rib which is a strip having a length of 0.4 to 10 cm and a width of 0.5 to 1 mm.

The present invention also provides a molded article prepared by the process for producing a molded article according to the present invention.

Preferably, the molded article is the housing or part of the housing of an electronic product, e.g., the housing of a laptop or a cell phone.

The molded article produced by the process according to the invention exhibits higher bonding strength in the bonding area between composite part and thermoplastic part, the bonding area does not include a bonding line, and surface defects in the bonding area are reduced or are almost not visible. Additionally, the process according to the invention significantly reduces the risk of warpage in the filling areas of the molded article. Moreover, owing to the non-overlap with the composite sheet, there is more space for holding the desired elements, such as an antenna.

In the present description, the percentage of a component in a composition or a mixture refers to percent by weight, unless otherwise defined. The thickness of a composite material sheet can vary between any ranges, unless otherwise specifically defined.

### DETAILED DESCRIPTION OF THE INVENTION

Step i)

A composite sheet in the sense of the present invention is a sheet comprising a thermoplastic material a and continuous fibers, preferably the composite sheet comprises at least three plies of fiber composite. The composite sheet preferably is the flat composite element used for forming the composite part, which more preferably is precutted flat composite sheet.

The plies of fiber composite of the composite sheet comprise continuous fibers, preferably unidirectionally aligned within the respective ply, and preferably embedded in a polycarbonate-based plastic.

“Unidirectional” in the context of the invention is to be understood as meaning that the continuous fibers are substantially unidirectionally aligned, i.e. point in the same direction lengthwise and thus have the same running direction. “Substantially unidirectional” is to be understood in this context as meaning that a deflection in the fiber running direction of up to 5% is possible. However, it is preferable when the deflection in the fiber running direction is markedly below 3%, particularly preferably markedly below 1%.

Examples of continuous fibers suitable in accordance with the invention are glass fibers, carbon fibers, basalt fibers, aramid fibers, liquid crystal polymer fibers, polyphenylene sulphide fibers, polyether ketone fibers, polyether ether ketone fibers, polyether imide fibers and mixtures thereof. The use of glass fibers or carbon fibers has proven particularly practical, wherein the use of carbon fibers is particularly preferred.

In the context of the invention the term “continuous fiber” is to be understood as differentiating from the short or long fibers which are also known to one skilled in the art. Continuous fibers preferably extend over the entire length of the ply of fiber composite. The term “continuous fibers” is derived from the fact that these fibers in general come wound on a roll and are unwound and impregnated with plastic during production of the individual plies of fiber composite so that, save for occasional breakage or changeover of rolls, the length of said fibers typically substantially corresponds to the length of the produced ply of fiber composite.

The form of the composite sheet is any free-form, depending on the design of the final molded article. Preferably, the composite sheet has a rectangular base area.

Preferably, in step i), the process further comprises a step of cutting the composite sheet made from the fiber reinforced thermoplastic polymer into preset shape by means of CNC cutting, water jet cutting, laser cutting or punching, wherein CNC cutting is particularly preferred. The shape of the sheet is determined according to shape of the housing of the specific electronic product.

In the process according to the present invention, there is no particular limitation to continuous fibers used for the composite sheet in step i), provided that they meet requirements in the field of electronic product housings, for example making the thermoplastic polymer filled with them meet the requirements of strength and the like. The fiber may have a diameter of for example from 1 to 100 μm, and preferably from 2 to 10 μm. The diameter of carbon fiber filaments, if used, is preferably in the range of 5 to 9 μm, in case of glass fibers preferably in the range of 12 to 25 μm.

Preferably, the thermoplastic material a of the composite sheet comprises polycarbonate; acrylonitrile-butadiene-styrene copolymer and/or polymethyl methacrylate, wherein polycarbonate is particularly preferred. The thermoplastic material preferably comprises at least 60 wt.-%, more preferably at least 75 wt.-%, particularly preferred at least 85 wt.-%, most preferred at least 90 wt.-% of polymer, in particular of aromatic polycarbonate.

The term “polycarbonate” in the sense of the present invention in particular means “aromatic polycarbonate”. These are not only homopolycarbonates, but also copolycarbonates. The polycarbonate can be linear or branched.

In the process according to the present invention, there is no particular limitation to the number-average molecular weight of the thermoplastic polymer a used for the composite sheet in step i), provided that it meets the requirements in the field of the electronic product housing. The thermoplastic polymer may have a Mn of for example from 5,000 to 1,000,000 g/mol, preferably from 10,000 to 300,000 g/mol, and more preferably from 20,000 to 100,000 g/mol.

The number-average molecular weight (Mn) is measured by Gel permeation chromatography (GPC), according to GB/T 21863-2008, Gel permeation chromatography (GPC)-Tetrahydrofuran as elution solvent (German standard DIN 55672-1:2007, Gel permeation chromatography (GPC), Part I: Tetrahydrofuran (THF) as elution solvent, IDT).

A portion, up to 80 mol %, preferably from 20 mol % to 50 mol %, of the carbonate groups in the polycarbonates suitable according to the invention can have been replaced by aromatic dicarboxylic ester groups. These polycarbonates which incorporate, into the molecular chain, not only acid moieties from carbonic acid but also acid moieties from aromatic dicarboxylic acids are termed aromatic polyester carbonates. For simplicity, the present application subsumes them within the umbrella term “thermoplastic, aromatic polycarbonates”.

The polycarbonates are produced in a known manner from diphenols, carbonic acid derivatives, and optionally chain terminators and optionally branching agents, and production of the polyester carbonates here involves replacing a portion of the carbonic acid derivatives with aromatic dicarboxylic acids or derivatives of the dicarboxylic acids, and specifically in accordance with the extent to which aromatic dicarboxylic ester structural units are intended to replace carbonate structural units in the aromatic polycarbonates.

Dihydroxyaryl compounds suitable for the production of polycarbonates are those of the formula (2)

HO—Z—OH (2),

in which

Z is an aromatic radical having 6 to 30 carbon atoms, it being possible for said radical to comprise one or more aromatic rings, to be substituted, and to contain aliphatic or cycloaliphatic radicals and/or alkylaryls or heteroatoms as bridging members.

Z in formula (2) is preferably a radical of the formula (3)

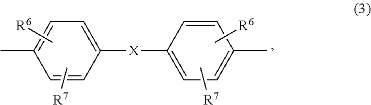

in which

R6 and R7 independently of one another are H, C₁- to C₁₈-alkyl, C₁- to C₁₈-alkoxy, halogen such as C₁ or Br, or aryl or aralkyl each of which is optionally substituted, and preferably are H or C₁- to C₁₂-alkyl, more preferably H or C₁- to C₈-alkyl, and very preferably H or methyl, and

X is a single bond, —SO₂—, —SO—, —CO—, —O—, —S—, C₁- to C₆-alkylene, C₂- to C₈-alkylidene or C₅- to C₆-cycloalkylidene which may be substituted by C₁- to C₆-alkyl, preferably methyl or ethyl, or else is C₆- to C₁₂-arylene, which may optionally be fused with aromatic rings containing further heteroatoms.

X is preferably a single bond, C₁- to C₅-alkylene, C₂- to C₅-alkylidene, C₅- to C₆-cyclo-alkylidene, —O—, —SO—, —CO—, —S—, —SO₂—

or a radical of the formula (3a)

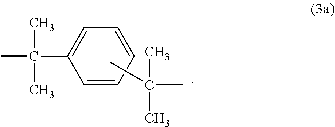

Examples of dihydroxyaryl compounds suitable for producing the polycarbonates for use in accordance with the invention include hydroquinone, resorcinol, dihydroxybiphenyl, bis(hydroxyphenyl)alkanes, bis(hydroxyphenyl)cycloalkanes, bis(hydroxyphenyl) sulphides, bis(hydroxyphenyl) ethers, bis(hydroxyphenyl) ketones, bis(hydroxyphenyl) sulphones, bis(hydroxyphenyl) sulphoxides, α,α′-bis(hydroxyphenyl)diisopropylbenzenes, and also their alkylated, ring-alkylated and ring-halogenated compounds.

Preferred dihydroxyaryl compounds are 4,4′-dihydroxybiphenyl, 2,2-bis(4-hydroxyphenyl)-1-phenyl-propane, 1,1-bis(4-hydroxyphenyl)phenylethane, 2,2-bis(4-hydroxyphenyl)propane, 2,4-bis(4-hydroxyphenyl)-2-methylbutane, 1,3-bis [2-(4-hydroxyphenyl)-2-propyl]benzene (bisphenol M), 2,2-bis(3-methyl-4-hydroxyphenyl)propane, bis(3,5-dimethyl-4-hydroxyphenyl)methane, 2,2-bis(3,5-dimethyl-4-hydroxyphenyl)propane, bis(3,5-dimethyl-4-hydroxyphenyl) sulphone, 2,4-bis(3,5-dimethyl-4-hydroxyphenyl)-2-methylbutane, 1,3-bis [2-(3,5-dimethyl-4-hydroxyphenyl)-2-propyl]benzene and 1,1-bis(4-hydroxyphenyl)-3,3,5-trimethylcyclohexane (bisphenol TMC).

Particularly preferred dihydroxyaryl compounds are 4,4′-dihydroxybiphenyl, 1,1-bis(4-hydroxyphenyl)phenylethane, 2,2-bis(4-hydroxyphenyl)propane, 2,2-bis(3,5-dimethyl-4-hydroxyphenyl)propane, 1,1-bis(4-hydroxyphenyl)cyclohexane and 1,1-bis(4-hydroxyphenyl)-3,3,5-trimethylcyclohexane (bisphenol TMC).

In the case of the homopolycarbonates, only one dihydroxyaryl compound is used; in the case of copolycarbonates, two or more dihydroxyaryl compounds are used. The dihydroxyaryl compounds used, and also all other auxiliaries and chemicals added to the synthesis, may be contaminated with the impurities originating from their own synthesis, handling and storage. It is desirable, however, to work with extremely pure raw materials.

As monofunctional chain terminators are needed in order to regulate the molecular weight, phenols or alkylphenols, especially phenol, p-tert-butylphenol, isooctylphenol, cumylphenol, the chlorocarbonic esters thereof or acyl chlorides of monocarboxylic acids, and/or mixtures of these chain terminators, are used.

Branching agents or mixtures of branching agents are selected from the group comprising trisphenols, quaterphenols or acyl chlorides of tricarboxylic or tetracarboxylic acids, or else mixtures of polyphenols or of acyl chlorides.

Examples of aromatic dicarboxylic acids suitable for producing the polyestercarbonates include ortho-phthalic acid, terephthalic acid, isophthalic acid, tert-butylisophthalic acid, 3,3′-biphenyldicarboxylic acid, 4,4′-biphenyldicarboxylic acid, 4,4-benzophenonedicarboxylic acid, 3,4′-benzophenonedicarboxylic acid, 4,4′-diphenyl ether dicarboxylic acid, 4,4′-diphenyl sulphone dicarboxylic acid, 2,2-bis(4-carboxyphenyl)propane and trimethyl-3-phenylindane-4,5′-dicarboxylic acid. Used with particular preference among the aromatic dicarboxylic acids are terephthalic acid and/or isophthalic acid.

Derivatives of the dicarboxylic acids are the dicarboxylic dihalides and the dicarboxylic dialkyl esters, especially the dicarboxylic dichlorides and the dicarboxylic dimethyl esters.

The replacement of the carbonate groups with the aromatic dicarboxylic ester groups takes place substantially stoichiometrically and also quantitatively, and so the molar ratio of the reactants is also found in the completed polyestercarbonate. The incorporation of the aromatic dicarboxylic ester groups may occur either randomly or in blocks.

Preferred modes of producing the polycarbonates for use in accordance with the invention, including the polyestercarbonates, are the known interfacial process and the known melt transesterification process (cf. e.g. WO 2004/063249 A1, WO 2001/05866 A1, WO 2000/105867, U.S. Pat. Nos. 5,340,905 A, 5,097,002 A, 5,717,057 A). In the first case, acid derivatives are preferably phosgene and optionally dicarboxylic dichlorides; in the latter case they are preferably diphenyl carbonate and optionally dicarboxylic diesters. Catalysts, solvents, work-up, reaction conditions, etc. for polycarbonate production and polyestercarbonate production have been widely described and are well known in both cases.

The polycarbonates, polyestercarbonates and polyesters can be worked up in a known way and processed to mouldings of any desired kind, by means of extrusion or injection moulding, for example. In the process according to the present invention, the composite sheet used in step i) can be produced by direct melt extrusion method, solvent method, powdering method, filmi method and the like, or it may be a commercial product, such as polycarbonate based continuous carbon fiber reinforced sheets from suppliers like Covestro, TenCate or Bond Laminates.

Step ii)

According to the present invention, applying thermoplastic material b in step ii) means that the desired volume of thermoplastic material b, which is a short fiber reinforced material, preferably short glass fiber reinforced, is applied at preset regions.

In the process according to the present invention, the preset region in step ii) is the site for forming the functional part and/or structural part in connection with the housing. Preferably, the functional part and/or structural part is selected from the group consisting of a signal sending and receiving area, a screw column, and a reinforcing rib. For the signal sending and receiving area, it may be, for example, in the form of two rectangles having a size of 6 cm×1 cm, and the sites of the two rectangles on the composite sheet may be arranged depending on the actual requirements. The screw column may be a cylinder having an inner diameter of 2.5 to 4 mm, and the site of the cylinder on the composite material blank sheet may also be arranged depending on the actual requirement. For the reinforcing rib, its position on the composite sheet may be arranged depending on the actual requirement, for example, the distance between the reinforcing rib and the upper edge of the composite sheet is 0.1-5 cm, and the reinforcing rib is parallel to the composite sheet in length direction and runs through the composite material blank sheet in length direction.

Preferably, in step ii), the one (or more) thermoplastic material b is(/are) disposed on the composite sheet through injection molding or three-dimensional (3D) printing.

Preferably, the thermoplastic polymer material b is applied by means of injection molding in step ii). In this case, the composite sheet provided in step i) may be inserted into the injection mold, as shown in FIG. 2a. When producing, the composite sheet which has been cut for example by CNC may be arranged into the mold previously, then the desired amount of thermoplastic polymer material b is injected at the preset regions of the composite sheet by injection molding, wherein said thermoplastic material b may be glass-fiber filled thermoplastic polymer materials, in particular aromatic polycarbonate. The injection of the polymer material b in a certain amount may be a material supplement at a precise position.

During the injection molding process, the thermoplastic material b is molded onto the composite sheet in defined volumes and at defined positions according to the design requirements of step iii), where the final geometry of the composite part and the backmolding structure are formed. The processing conditions of injection molding may be determined according to the specific thermoplastic polymer materials. For example, in the case of using polycarbonate reinforced with a high amount of glass fiber as the thermoplastic material b, the temperature for injection molding may be 240 to 310° C., the mold temperature may be 70 to 110° C., the injection pressure may be 85 to 240 MPa, and the back pressure may be 0.3 to 1.4 MPa.

Alternatively, the thermoplastic polymer b is applied by 3D printing in step ii). In this case, the thermoplastic material b is applied layer-by-layer to the preset region of composite sheet in a way of fused deposition using three-dimensional printer controlled by the computer, without inserting an insert with a mold. The 3D printing may be carried out in a simple way such that the thermoplastic material b is arranged in the preset region, without using any molds.

The processing conditions of 3D printing have to be determined according to the specific thermoplastic polymer. For example, the temperature of 3D printing may be 260 to 310° C. in the case of using aromatic polycarbonate, in particular reinforced with high amount of glass fiber as thermoplastic polymers.

The application of the thermoplastic polymer material b in step ii) by means of injection molding is preferred.

In the process according to the present invention, there is no particular limitation to the short fiber comprising thermoplastic material b in step ii). It may contain any thermoplastic polymer used for forming a functional part on the electronic product housing. Preferably, the thermoplastic material b is selected from the group consisting of polycarbonate (PC), acrylonitrile-butadiene-styrene copolymer (ABS), polymethyl methacrylate (PMMA) or combinations thereof, wherein aromatic polycarbonate is particularly preferred. The thermoplastic polymer may have a number-average molecular weight (Mₙ) of from 5,000 to 1,000,000 g/mol, preferably from 10,000 to 300,000 g/mol, and more preferably from 20,000 to 100,000 g/mol.

The thermoplastic material b in step ii) is reinforced with short fibers, wherein the fibers may, for example, be synthetic fibers (such as polyester fibers), carbon fibers or glass fibers, but are not limited thereto. The short fibers preferably are glass-fibers, more preferably glass fibers having an average length of 0.2-10 mm, more preferably 1-8 mm, most preferably 2-6 mm.

Particularly preferably, the thermoplastic polymer material of step ii) achieves a V0 rating at a thickness of 0.5-3.0 mm in the UL 94 test.

If there are several structural and/or functional parts, different polymer materials can be used for the different parts.

In the step ii) of the process according to the present invention, the fiber reinforced thermoplastic resin pellets may be produced by mixing short fibers and thermoplastic resins as matrix material in a desired proportion and then processing the mixture in a common manner (for example pelletizing) in the polymer field. These are likewise commercial products, for example 50 wt.-% glass fiber reinforced polycarbonate Makrolon® GF9020 from Covestro.

In the step ii) of the present invention, the thermoplastic material b for forming the thermoplastic part is disposed at a preset region in a preset amount on the composite sheet. Specifically, in the process according to the present invention, the preset amount has no particular limitation. Preferably, it is the amount required for forming the desired thermoplastic part.

In the signal sending and receiving area, the disposed thermoplastic material b may be a glass-fiber filled thermoplastic polymer, in particular a short glass fiber filled aromatic polycarbonate. In the areas other than the signal sending and receiving area, the disposed thermoplastic material b may comprise carbon fibers instead.

Step iii)

In the process according to the present invention, for the thermoforming in step iii), the thermoplastic material b was applied in the preset region in step ii), so as to form one or more functional areas, functional parts and/or structural parts in a desired area of the composite sheet during the thermoforming of step iii). This gives a final molded article after the thermoforming.

In step iii), the final article will be formed precisely, wherein the thermoplastic material b in step ii) was disposed in the preset region of the composite sheet provided in step i).

In the process according to the present invention, the mold applied can be a rapid heat and rapid cool mold, the temperature of the mold shall be able to raise up to 400° C. to fit for different thermoplastic composite materials and the mold shall be designed in a way to realize homogeneous temperature distribution during heating and cooling. The thermoforming conditions thereof may be determined by the type of the thermoplastic base material of the composite sheet and of the material of the thermoplastic part. In the case of aromatic polycarbonate, the thermoforming temperature in the thermoforming process may be, for example, from 160 to 230° C. and the thermoforming pressure may be 5 to 20 MPa, preferably from 10 to 15 MPa.

During the thermoforming, the composite sheet, which had been fed with the starting material in a desired area (applied thermoplastic material b), is processed into a final molded, preferably three-dimensional article.

After the thermoforming, the resulting final article is preferably coated. As to the coating, it may have a variety of functions such as being an insulating layer to increase the safety, or being a skin-like coating to improve the touch, or being coated with a piano baking varnish to decorate the surface.

However, in step iii), a film layer may also be placed on the surface of the composite sheet before the thermoforming to complete surface decoration in this step as well, without additional coating steps, wherein the film layer is positioned on the opposite site of the sheet to the thermoplastic material b for forming the thermoplastic part. The film layer may have the functions of the above coatings and may be a peelable layer or non-peelable layer, depending on specific requirements. Subsequently, it may be formed as the final article together with the composite material blank sheet by means of thermoforming.

Preferably, the molded article obtained according to the process of the present invention is the housing of an electronic product. Particularly preferred this is the housing of a laptop or a cell phone.

The injection molding performing in the process of the present invention allows a relatively simple injection molding tool and a lower requirement on precision for the mold in step ii, compared with the steps of firstly thermoforming followed by injection molding to form functional parts in the prior art.

Furthermore, the process according to the present invention achieves an integral-molded final article by firstly applying the thermoplastic material b for forming functional parts at predetermined positions of a composite sheet, and then integrally thermoforming the whole sheet. Since it is only necessary to charge at specific positions by injection molding or 3D printing during application of thermoplastic polymer for forming functional areas, functional parts and/or structural parts in step ii), the areas needs to be injection molded or 3D printed (for example antenna area, bosses, ribs) can be relatively much smaller than in the prior art, which in most cases requires overmolding in the whole frame of the composite sheet. Therefore the possibility of warpage is accordingly significantly reduced. In addition, due to the simple process for charging, the requirements on the mold for injection molding are lower, and injection molding is even not needed in the case of 3D printing, thus the mold cost being significantly reduced. In step iii), the composite sheet where the preset positions are already injection molded or 3D printed with required thermoplastic materials will be thermoformed, depending on the matrix resin material in the composite sheet and thermoplastic polymer, relatively higher forming temperature is needed (much higher than mold temperature in injection molding process) to thermoform the composite sheet. In case a composite sheet with a polycarbonate material as matrix material and as thermoplastic material for the functional and/or structural parts would be applied, a thermoforming temperature in the range of 150° C. to 230° C. is needed, more preferably 170° C. to 210° C. is required to form the composite sheet. During thermoforming process, the thermoplastic matrix resin in the composite sheet and injection molded thermoplastic polymers will be heated and well melted and mixed with each other, thus forming strong bonding strength.

Compared with the bonding areas of articles formed by firstly hot pressing molding and then injection molding in the prior art, in the process according to the present invention, due to the characteristics of the hot pressing molding itself, the thermoplastic materials of the composite sheet and those positioned at predetermined positions will be well melted and mixed with each other and cooled down under pressure, which leads to a much higher bonding strength. In addition, since the bonding as mentioned in the present invention is achieved by the thermoforming, the surfaces at the bonding area are at the same level, thus eliminating the bonding line. Accordingly, it is not necessary to carry out subsequently the polishing step at bonding areas. Meanwhile, the surface defects at the bonding areas are considerably decreased in number or are substantially unidentified.

In another aspect, the present invention further provides a molded article, which is obtained by the process for producing molded articles according to the present invention.

For the molded article according to the present invention, the embodiments mentioned above in description to the process for producing molded articles also apply, the details of which is thus omitted.

### DESCRIPTION OF THE DRAWINGS

The present invention is further illustrated with the help of the following figures, but is not limited thereto.

FIG. 1 is the schematic drawing of the composite sheet used as cover-A of a laptop in an exemplary embodiment according to the present invention, which is cut by a computer numerical controlled machine (CNC).

FIG. 2 is the schematic drawing of supplementing materials (applied thermoplastic polymer) in the preset region of the composite sheet through a) injection molding or b) three-dimensional printing in an exemplary embodiment according to the present invention.

FIG. 3 is a figure displaying the deflection (deformation) of sample that varies with the load in an exemplary embodiment according to the present invention.

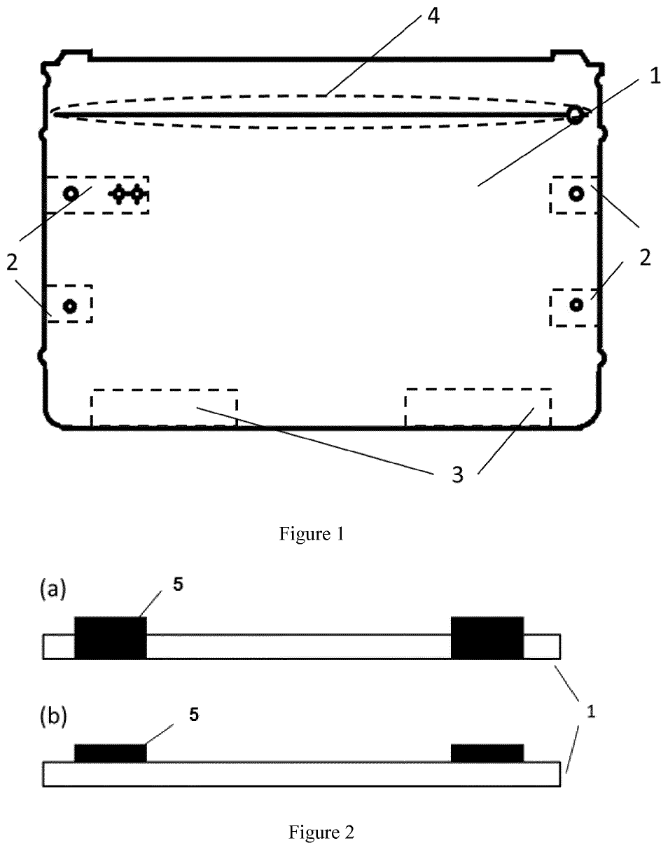

FIG. 1 shows an exemplary embodiment according to the present invention in which 1 represents a composite sheet. When performing CNC cutting, the composite sheet is first cut into preset size, and then is cut to obtain edges, including projections and depressions, according to specific requirements for molding articles such as an A-Cover of a laptop. These may be adjusted in accordance with the respective product. In addition, since conventional carbon fiber reinforced thermoplastic polymeric composites have electromagnetic shielding for wireless signals, it is needed to cut a signal sending and receiving area 3 at the lower position of the composite sheet in the course of producing an A-Cover of the laptop. This area can be supplemented with glass fiber reinforced thermoplastic polymers having no electromagnetic shielding, as described below. The material supplement of a region having special structure for example a longer reinforcing rib may be employed by means of designing the mold to supplement the material on the surface of composite sheet by injection molding. The resulting composite blank sheet has a shape as shown in FIG. 1, wherein it generally has a thickness of about 0.60 to 1.4 mm. The size and thickness thereof, however, are not limited thereto, but can be adjusted in wide ranges according to actual requirements.

### EXAMPLES

With reference to the examples below, the present invention will be described in detail. These examples are only for the purpose of illustration, instead of intending to limit the scope of the present invention.

Raw Material and Apparatus

continuous carbon fiber-reinforced polycarbonate composite sheet (fibers unidirectionally aligned) containing 50 vol.-% carbon fibers, CF FR1000, from Covestro;

short glass fiber-reinforced polycarbonate containing 50 wt.-% glass fibers, Makrolon® GF9020, available from Covestro;

Injection molding machine, ENGEL DUO 3550/650, available from Engel Machinery Co., Ltd.;

Hot pressing molding machine, HPFM-500A, available from Dongguan Qiaolian Machine Co., Ltd.;

Load-deformation tester, 9603SP, available from SE Testsystems Co., Ltd.

### Example 1

Preparation of Molded Article According to the Invention

i) A composite sheet CF FR1000 with a thickness of 1.0 mm was cut into a size of 324 mm length and 210 mm width by CNC.

ii) The cut composite sheet was positioned into a mold of the injection molding machine, the mold was closed and the injection was performed to apply the required amount of thermoplastic materials b onto the composite sheet, so that 8 cm³ of glass fiber-reinforced polycarbonate Makrolon® GF9020 (50 wt.-% glass fibers) was injection molded into a signal sending and receiving area 3, and 0.6 cm³ and 1.3 cm³ of glass fiber-reinforced polycarbonate Makrolon® GF9020 (50 wt.-% glass fibers) were injection molded into a screw column 2 and a reinforcing rib 4, respectively (as shown in FIG. 1); wherein the melt temperature for injection molding was 300° C., the mold temperature was 90° C., the injection pressure was 100 MPa, and the back pressure was 0.8 MPa; and wherein signal sending and receiving area 3 was in the form of two 6 cm×1 cm×0.1 cm (l×w×h) rectangles, the symcenter of the two rectangles having a distance from the lower edge of the composite material sheet of 0.2 cm, and each of the left/right rectangle having a distance from the left/right edge of the composite material sheet of 1 cm, screw column 2 was a cylinder with an inner diameter of 3 mm, the axis of which had a distance from the left/right edge of the composite material sheet of 0.3 cm, and reinforcing rib 4 was a stick with a width of 0.43 cm, which had a distance from the upper edge of the composite material sheet of 1 cm, was parallel to the composite sheet in length direction and ran through the composite sheet in length direction.

iii) After completion of injection and after cooling down and demoulding, the composite sheet on which the requested volume of thermoplastic material was added to the preset region by injection molding process, during thermoforming process the added thermoplastic material was formed into functional areas, functional and/or structural parts on the composite sheet. For the thermoforming process, the mold temperature was set at 200° C. and the sheet was heated up, the sheet was kept at this temperature for about 30-60 see, then a pressure of about 15 MPa was applied and held for about 20-30 sec on the sheet to thermoform it. The composite part with the structural and/or functional parts was subsequently cooled and demoulded, to give the molded article according to the invention of sample 1.

### Example 2

Preparation of Molded Article in the Prior Art

i) A composite sheet CF FR1000 with a thickness of 1.0 mm was cut into a size of 324 mm length and 210 mm width by CNC, using the process as described in step i) of Example 1.

ii) The precut sheet was placed in the thermoforming mold, the mold temperature was set at 200° C. and the sheet was heated up and was kept at this temperature for about 30-60 see, then a pressure of about 15 MPa was applied and held for about 20-30 sec on the sheet to thermoform the sheet. Afterwards, the mold was cooled down to about 75° C. and the formed sheet, the composite part, was demolded.

iii) The above mentioned composite part was placed in the injection molding mold, the barrel temperature was set at 280-320° C., injection speed profile (max injection speed at 150 mm/s) and holding pressure were set at 70% of max injection pressure, then the edges of the sheet were overmolded to form bosses, ribs, edges and antenna areas.

After completion of injection and after demoulding and cooling down, the molded article in the prior art of sample 2 was given.

Performance Test

The samples 1 and 2 as given above were tested. During testing, the sample was put on the platform of a load-deformation tester 9603SP available from SE Testsystems Co., Ltd., and extruded at a front edge thereof (which was located at the bonding areas in the two-step molding) by using a probe. On the basis of an initial load, the force loaded on the sample was increased gradually, and meanwhile the deflection of the sample surface was measured relative to the horizontal plane, until ruptures occurred in the sample. The testing parameters were as shown in Table 1.

TABLE 1

| | Distance between | Distance between | Distance between | | | | | |
|---|---|---|---|---|---|---|---|---|
| | the center of the | the center of the | the center of the | | | | | |
| | probe and the right | probe and the left | probe and the front | Initial | probe | Load | Deflection | Load |
| | edge of the sample | edge of the sample | edge of the sample | load | diameter | range | range | speed |
| Sample | (mm) | (mm) | (mm) | (kgf) | (mm) | (N) | (mm) | (mm/min) |
| 1 | 246 | 78 | 3 | 0.01 | 10 | 500 | 5 | 2 |
| 2 | 246 | 78 | 3 | 0.01 | 10 | 500 | 5 | 2 |

The testing results were as shown in Table 2.

TABLE 2

| | Maximum deflection before the | |
|---|---|---|
| Sample | rupture (mm) | Max load (N) |
| 1 | 2.130 | 246.8 |
| 2 | 1.270 | 122.6 |

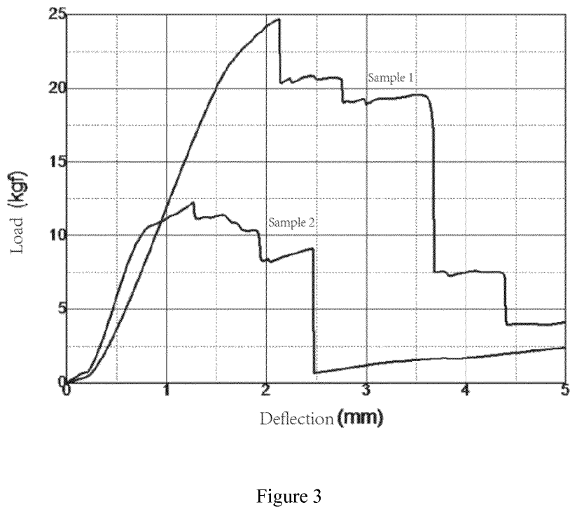

FIG. 3 shows that the deflection of the two samples changes as the load changes. It can be seen from the results in Table 2 and FIG. 3 that the bonding strength at bonding areas of sample 1 according to the present invention is significantly greater than that of sample 2 obtained by the process according to the prior art. Furthermore, it was identified that the surface defects at bonding areas were considerably reduced, and no warpage occurred at the filled areas in case of the molded article according to the invention. In addition, the mold used in the injection molding of the process according to the invention was simpler than the one used in the injection molding of the process in the prior art, and the cost was lower.

The above are only preferred examples of the present invention, being not employed to limit the invention. For those skilled in the art, various modifications and variations can be made to the compositions and methods of the present invention without departing from the scope of the invention. With reference to the disclosure in the present description, those skilled in the art may also reach other examples. The present description and examples should be only regarded as illustrative, and the true scope of the present invention is defined by the appended claims and their equivalents.

1.-10. (canceled)

11. A process for producing a molded article which comprises a composite part and at least one functional and/or structural thermoplastic part, wherein the composite part and the functional and/or structural thermoplastic part are directly attached to each other, wherein the process comprises the following steps:
i) providing a composite sheet containing a thermoplastic material a and continuous fibers and comprising at least one preset region used for forming said at least one functional and/or structural thermoplastic part,
ii) applying a preset volume of thermoplastic material b comprising short fibers at said at least one preset region by 3D printing layer-by-layer in a way of fused deposition using three-dimensional printer controlled by the computer, without inserting an insert with a mold; and
iii), thermoforming said composite sheet and said thermoplastic material b into the molded article in one step, wherein the composite sheet is thermoformed to form said composite part and the thermoplastic material b is thermoformed to form the at least one functional and/or structural thermoplastic part.

12. The process according to claim 11, wherein said molded article is a housing or part of a housing of an electronic product.

13. The process according to claim 12, wherein said molded article is a housing or part of a housing of a laptop or a cell phone.

14. The process according to claim 11, wherein the thermoplastic material a and/or the thermoplastic material b is/are selected from the group consisting of polycarbonate, acrylonitrile-butadiene-styrene copolymer, polymethyl methacrylate, or the combination thereof.

15. The process according to claim 11, wherein said composite sheet is a carbon fiber- or glass fiber-reinforced polycarbonate composite sheet.

16. The process according to claim 11, wherein the continuous fibers are unidirectionally aligned.

17. The process according to claim 11, wherein said functional or structural part is selected from the group consisting of a screw column, a signal sending and receiving area and/or reinforcing ribs.

18. The process according to claim 11, wherein the short fibers are glass fibers.

19. A molded article produced by the process according to claim 11.

20. The molded article according to claim 19, wherein the article is a housing or part of a housing of a laptop or a cell phone.
